(19) United States
(12) Patent Application Publication
(10) Pub. No.: US 2015/0102885 A1
(43) Pub. Date: Apr. 16, 2015

(54) TRANSFORMER

(71) Applicant: DELTA ELECTRONICS (Jiangsu) Ltd., Wujiang City (CN)

(72) Inventors: Xiao-Xia YUAN, Wujiang City (CN); Zhi-Liang ZHANG, Wujiang City (CN); Shao-Dong ZHANG, Wujiang City (CN)

(21) Appl. No.: 14/457,174

(22) Filed: Aug. 12, 2014

(30) Foreign Application Priority Data
Oct. 15, 2013 (CN) 201310482284.8

(51) Int. Cl. H01F 27/26; H01F 27/29

(52) U.S. Cl. CPC H01F 27/266; H01F 27/29
USPC 336/192; 336/221

(57) ABSTRACT

The present invention provides a transformer including a coiling frame, an iron core, and a fastener. There is a wire twining round the coiling frame, which has a through hole inside thereof. The iron core extends through the through hole and forms a magnet loop. The fastener comprises a first component and a second component. The first component connects with the second component in a horizontal direction thereby surrounding and fixing the coiling frame and the iron core. One advantage of the present invention is that the fastener fixing the coiling frame and the iron core has a split structure. The fastener is assembled with the coiling frame directly, and a combination of the coiling frame and the iron core need not be vertically assembled with the fastener so as to make the transformer assembling easier and avoid the size of the transformer troublesome.

### FIELD OF THE INVENTION

The present invention relates to an electric product field, and more particularly to a transformer.

### BACKGROUND OF THE INVENTION

FIG. 1 is an exploded view of one kind of transformer in the prior art. Please refer to FIG. 1, the transformer 1 comprises an upper iron core 10, a lower iron core 11, a coiling frame 12 and a pitch positioning fastener 13. The transformer 1 is assembled by the following steps: coiling wire on the coiling frame 12; assembling the coiling frame 12, the upper iron core 10 and the lower iron core 11 vertically; assembling the assembled upper iron core 10, the coiling frame 12 and the lower iron core 11 to the pitch positioning fastener 13 vertically; and connecting the wire coiled on the coiling frame 12 to the pitch positioning fastener 13.

The transformer 1 has the following defects: 1. It is difficult to assemble the coiling frame 12, the upper iron core 10, the lower iron core 11 and the pitch positioning fastener 13 in vertical direction in the assembling steps; 2. After assembling the lower iron core 11 into place, a gap is existed between a bottom of the lower iron core 11 and a bottom of the pitch positioning fastener 13, thereby leading to bad size and bad noise test.

### SUMMARY OF THE INVENTION

The object of the present invention is to overcome the shortcoming of the conventional technology and provide a transformer having no sealed gap between the lower iron core and the fastener and being easy to assemble.

In order to solve the above technical problem, the present invention provides a transformer comprising a coiling frame, an iron core, and a fastener. The coiling frame has a wire twining round thereon and a through hole inside thereof. The iron core extends through the through hole and forms a magnet loop. The fastener comprises a first component and a second component. The first component and the second component are connects together in a horizontal direction thereby surrounding and fixing the coiling frame and the iron core.

The first component and second component are two individual parts.

The fastener is configured with an opening on the bottom thereof. The iron core is exposed to the opening of the fastener completely or partly therefore there is no sealed space between the bottom of the iron core and the fastener.

The area of the opening is larger than one-half of the area of the bottom of the fastener.

The bottom of the fastener contacting with the iron core is a hollow structure for exposing the iron core partly therefore there is no sealed space between the bottom of the iron core and the fastener.

A connecting manner of connecting the first component and the second component is one of the adhesive bonding connection, fastening fixation connection and mechanism parts connection.

The fastener is configured with electrical pins and the wire on the coiling frame connects with the electrical pins.

One advantage of the present invention is that the fastener fixing the coiling frame and the iron core has a split structure. The fastener is assembled with the coiling frame directly, and a combination of the coiling frame and the iron core need not be vertically assembled with the fastener so as to make the transformer assembling easier and avoid the size of the transformer troublesome.

Another advantage of the present invention is that the bottom of the fastener is configured with an opening which leads no sealed space between the bottom of the fastener and the bottom of the iron core for avoiding vibration of the air in a gap between the bottom of the fastener and the bottom of the iron core.

For a more complete understanding of the present invention, and the advantages thereof, reference is now made to the following descriptions taken in conjunction with the accompanying drawings.

### DESCRIPTION OF THE DRAWINGS

FIG. 1 is an exploded view of a transformer in the prior art;

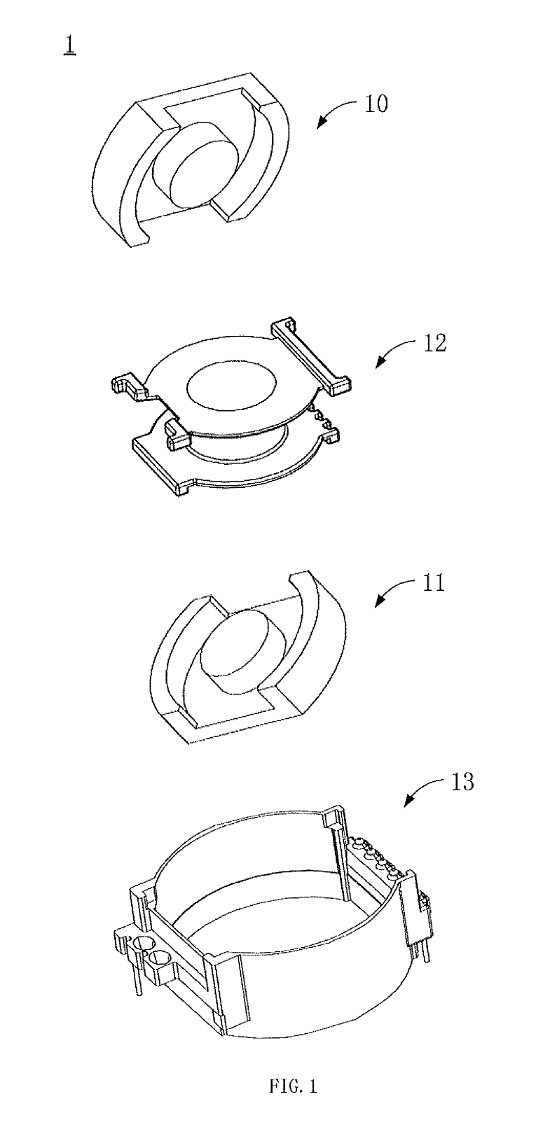

FIG. 2 is an exploded view of a transformer of the present invention;

FIG. 3 is an assembled view of the transformer of the present invention;

FIG. 4 is an enlarge view of portion A of a first component shown in FIG. 2; and

FIG. 5 is an enlarge view of portion B of a second component shown in FIG. 2.

### DETAILED DESCRIPTION OF THE PREFERRED EMBODIMENT

The foregoing has outlined rather broadly the features and technical advantages of the present invention in sequence that the detailed description of the invention that follows may be better understood.

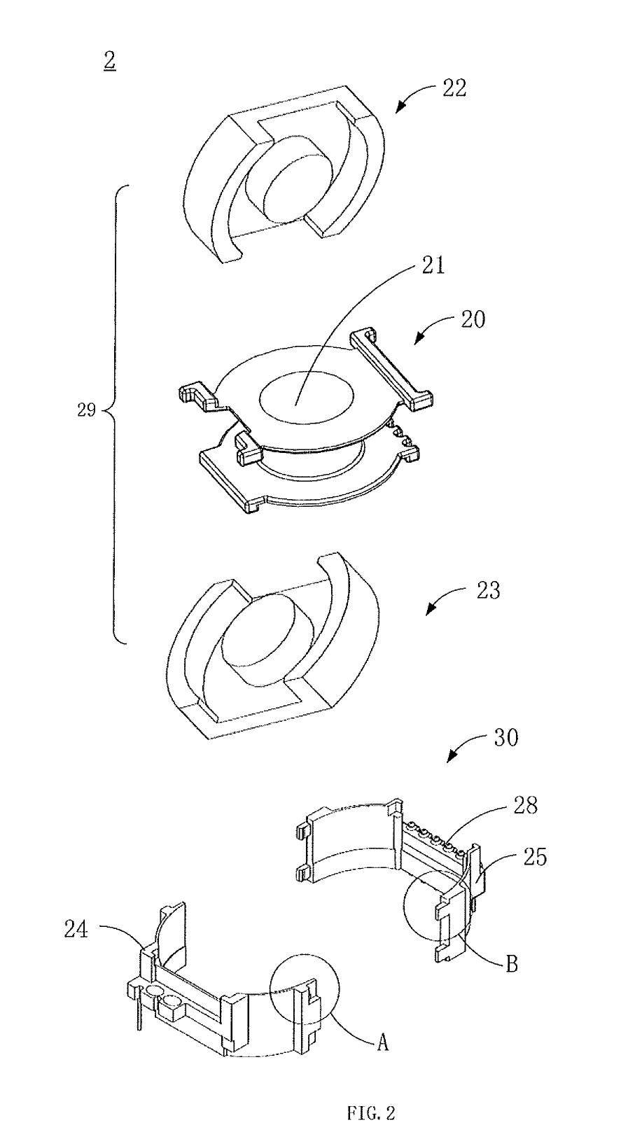

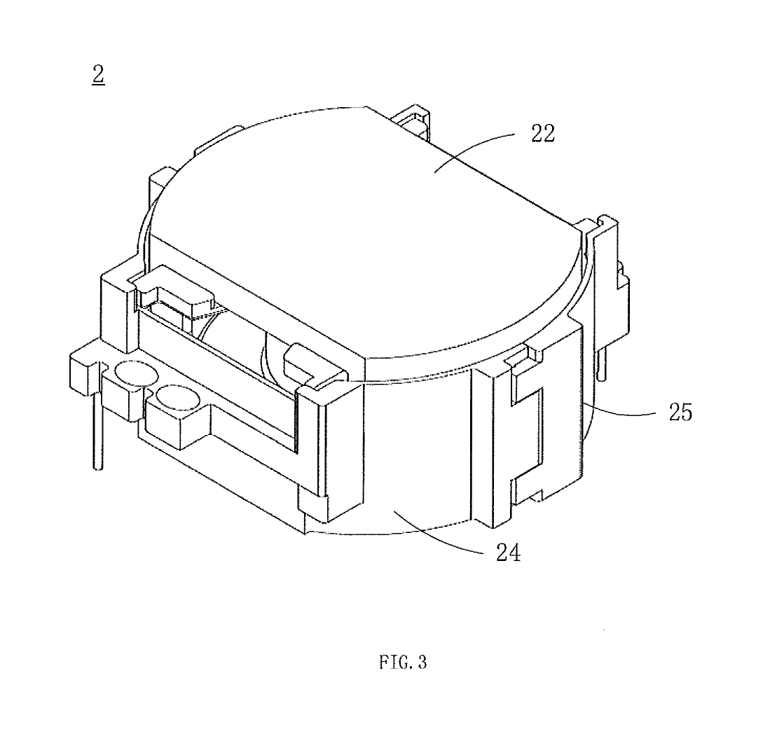

FIG. 2 is an exploded view of the transformer 2 of the present invention. FIG. 3 is an assembled view of the transformer 2 of the present invention. Please refer to FIG. 2 and FIG. 3, the transformer 2 of the present invention comprises a coiling frame 20, an iron core 29 and a fastener 30.

There is a wire twining round the coiling frame 20 for forming a primary winding and a secondary winding (not labeled in the drawings). The wire is wrapped with an insulating layer, such as enameled wire for preventing short circuit by contacting between one segment of the wire with another segment of the wire. The coiling frame 20 defines a through hole 21 extending through the coiling frame 20. A central part of the iron core 29 can extend through the through hole 21. The iron core 29 extends through the through hole 21 of the coiling frame to form a closed magnetic loop.

The iron core 29 can be any shapes to fit for combining with the coiling frame 20, such as an E shape, an El shape and a UU shape. In the embodiment, the iron core 29 is the E shape. Please refer to FIG. 2, the iron core 29 comprises an E shaped upper iron core 22 and an E shaped lower iron core 23. The upper iron core 22 and the lower iron core 23 together extend into the through hole 21 of the coiling frame 20 and connect with each other in the through hole 21 for forming the closed loop.

The fastener 30 comprises a first component 24 and a second component 25. The first component 24 connects with the second component 25 in a horizontal direction thereby surrounding and fixing the coiling frame 20 and iron core 29. Preferably, the first component 24 and the second component 25 are two individual parts. A connection between the first component 24 and the second component 25 is one manner of adhesive bonding connection, fastening fixation connection and mechanism parts connection to fix the coiling frame 20 and the iron core 29.

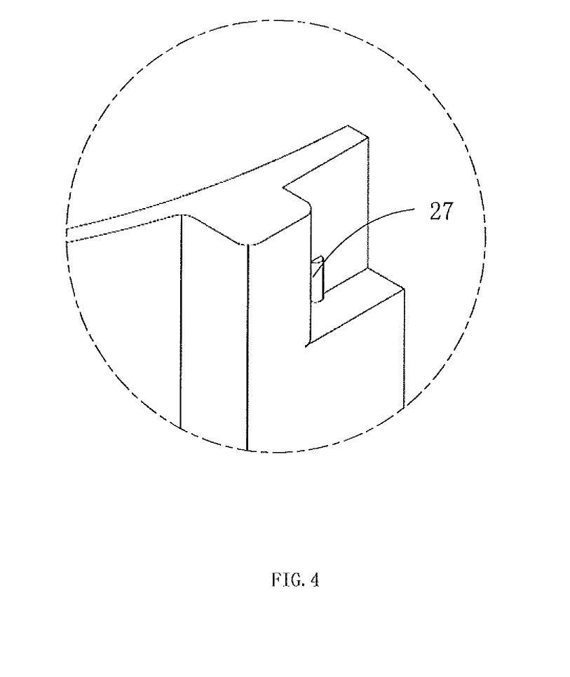

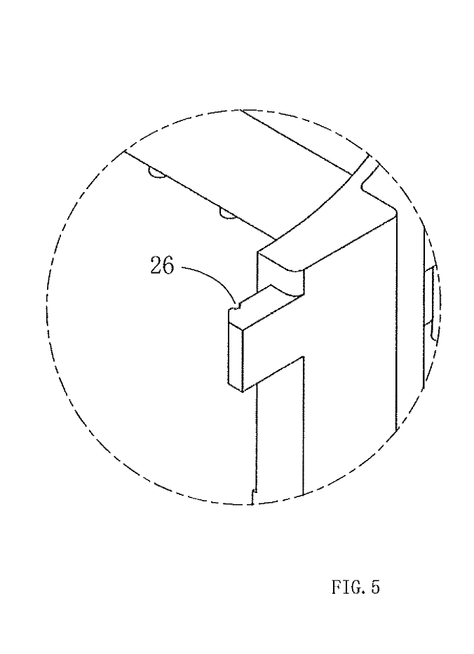

In the detailed embodiment of the present invention, the connecting manner between the first component 24 and the second component 25 is the fastening fixation connection. FIG. 4 is an enlarge view of portion A of the first component 24 shown in FIG. 2. FIG. 5 is an enlarge view of portion B of the second component 25 shown in FIG. 2. Please refer to FIG. 4 and FIG. 5, each end of the first component 24 has a stuck point 27 and each end of the second component 25 has a stuck slot 26. When the first component 24 and the second component 25 engage with each other, the corresponding stuck points 27 and the stuck slots 26 lock with each other thereby connecting the first component 24 and second component 25 together.

The first component 24 and the second component 25 of the fastener 30 connect with each other in the horizontal direction from both sides of the coiling frame 20 and are assembled with the coiling frame 20 directly thereby avoiding a vertical assembly between a combination of the coiling frame 20 and the iron core 29 and the fastener so as to make the transformer 2 assembling easier.

Further, an opening (not labeled) is defined in a bottom of the fastener 30 which contacts with the iron core 29. The iron core 29 is exposed to the opening completely or partly so that there is no sealed space between the bottom of the iron core 29 and the fastener 30. In the present invention, after the first component 24 connects with the second component 25, a full opening is defined in the bottom of the fastener 30 and the iron core 29 is exposed to the opening completely. An advantage of defining the opening in the bottom of the fastener 30 is that there is no sealed space between the bottom of the fastener 30 and the bottom of the iron core 29 for avoiding air vibration in a gap between the bottom of the fastener and the bottom of the iron core and reducing noise when the transformer 2 operates. Preferably, the opening is a partial opening. The area of the partial opening is larger than one-half of the area of the bottom of the fastener so that the fastener 30 can both support the iron core 29 and prevent air vibration from producing noise.

In other embodiments of the present invention, the bottoms of the first component 24 and the second component 25 of the fastener 30 are hollow structure for partly exposing the iron core 29. The hollow structure can support the iron core 29 and there is no sealed space between the bottom of the iron core and the fastener so as to prevent air vibration from producing noise.

The fastener 30 is configured with electrical pins 28 and the wire on the coiling frame 20 connects with the electrical pins. The electrical pins 28 connect with other elements. In the present embodiment, the first component 24 is configured with a plurality of electrical pins 28. A pitch between every both adjacent pins 28 is a constant distance so that the fastener 30 can achieve the positioning of the pins.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transformer, comprising: a coiling frame, an iron core, and a fastener, the coiling frame having a wire twining round thereon and a through hole inside thereof, a central part of the iron core extending through the through hole to form a magnet loop, the fastener comprising a first component and a second component, the first and the second components being connected together in a horizontal direction thereby surrounding and fixing the coiling frame and the iron core.

2. The transformer according to claim 1, wherein the first component and second component are two individual parts.

3. The transformer according to claim 1, wherein the fastener is configured with an opening on the bottom thereof and the iron core is exposed to the opening of the fastener completely or partly and there is no sealed space between the bottom of the iron core and the fastener.

4. The transformer according to claim 3, wherein the area of the opening is larger than one-half of the area of the bottom of the fastener.

5. The transformer according to claim 1, wherein the bottom of the fastener contacting with the iron core is a hollow structure for exposing the iron core partly and there is no sealed space between the bottom of the iron core and the fastener.

6. The transformer according to claim 1, wherein a connecting manner of connecting the first component and the second component is one of the adhesive bonding connection, fastening fixation connection and mechanism parts connection.

7. The transformer according to claim 1, wherein the fastener is configured with electrical pins and the wire on the coiling frame connects with the electrical pins.
